(19) United States
(12) Patent Application Publication
(10) Pub. No.: US 2011/0136026 A1
(43) Pub. Date: Jun. 9, 2011

(54) HYBRID POWER PLANT SYSTEM FOR VEHICLES

(75) Inventors: Daniel Augusto Betts, Parkland, FL (US); Matthew Graham, West Palm Beach, FL (US); Michel Fuchs, Palm Beach Gardens, FL (US); James Braun, Loxahatchee, FL (US)

(73) Assignee: ENERFUEL INC., West Palm Beach, FL (US)

(21) Appl. No.: 12/790,701

(22) Filed: May 28, 2010

Related U.S. Application Data
(60) Provisional application No. 61/266,468, filed on Dec. 3, 2009.

(51) Int. Cl. H01M 8/06; H01M 8/04

(52) U.S. Cl. 429/423; 429/512; 429/443

(57) ABSTRACT

A vehicle power plant includes a high temperature PEM fuel cell system operatively connected to a battery pack. A power conditioner is operatively connected between the PEM fuel cell system and the battery pack. The system can include a fuel processor, such as a steam reformer or an autothermal reformer. The reformer can be designed such that it can reform a wide range of fuels. The system can provide for a vehicle with a much higher driving range at a potentially lower cost than an equivalent range battery-only electric vehicle. The integration of these components into a single system also allows the vehicle to be fuel flexible; that is, capable of being fueled with a wide range of fuels without hardware changes in the system.

### CROSS-REFERENCE TO RELATED APPLICATIONS

This application claims the benefit of U.S. Provisional Application No. 61/266,468, filed on Dec. 3, 2009, which is incorporated herein by reference in its entirety.

### FIELD

Embodiments relate in general to energy storage and generation devices and, more particularly, to the use of such devices to support vehicle propulsion.

### BACKGROUND

Typically, electric power for the propulsion of an electric vehicle is provided by batteries. These batteries are typically charged using electricity from an electrical grid, through a plug-in mechanism. State of the art batteries are capable of electrically storing energy in a mass envelope that is significantly heavier than state of the art internal combustion engines, external combustion engines, and fuel cells. For this reason, the driving range of battery-powered electric vehicles is limited by the weight, size and cost of the batteries necessary to store the energy necessary to provide the desired vehicle range. Consequently, battery electric vehicle range is typically lower than that of equivalent internal combustion, external combustion or fuel cell powered vehicles.

Charging the batteries of battery-only electric vehicles is also a time consuming and energy intensive process. These characteristics exacerbate the battery-only electric vehicle range problem since there is a time penalty associated with reaching the vehicle's range limit prior to reaching the driver's destination. The term “range anxiety” has been coined for the stressful feeling many battery-only electric vehicle drivers experience as the state of charge of their vehicle battery is reduced.

Finally, a major limitation to battery-only electric vehicles is that they can only be refueled (or recharged) with electricity. As a result, the environmental impact of the vehicle is bound to the way the electricity is produced, a matter that most users have very little control over. In regions where electricity is produced primarily from coal, the environmental impact of a battery electric vehicle may be higher than an equivalent gasoline vehicle.

To solve the battery-only electric vehicle range, fueling time, and fueling source problems, the incorporation of an internal combustion engine, external combustion engine, or fuel cell generator have been proposed. These generators can be fueled using available fuels. The energy carried by the vehicle is thus increased by the chemical energy of the fuel minus the inefficiencies associated with converting the chemical energy of the fuel to electrical energy. The generator is primarily used to recharge the vehicle's batteries or reduce the electrical energy draw from the batteries.

However, the use of internal combustion engines with a battery pack is technically complex and typically leads to excessive energy losses that drive down the vehicle efficiency and increase engine size requirements. The primary barrier is the conversion of the output energy of the internal combustion engine, which is in the form of mechanical energy, to electrical energy through a generator. Furthermore, the electrical output of the generator must be converted to match the voltage of the vehicle battery. These energy conversion steps reduce the overall efficiency of the engine while increasing weight, size, and cost.

Moreover, internal combustion engines inherently produce nitrogen oxide (NOx) emissions due to the erratic combustion process and the compression and expansion process in the combustion chamber. High combustion temperatures and high pressures promote NOx formation. NOx is a precursor of low-lying ozone formation, which is a major contributor to lung disease and chronic asthma in children.

Finally, while combustion engines can be fueled with a variety of fuels, they are seldom capable of being fueled with multiple types of fuels. For example, it is highly uncommon for an unleaded gasoline engine to have the capacity to run with diesel fuel. The limitations are due to the differences in compression and expansion requirements for each type of fuel. Moreover, each fuel has a different lubricity and materials requirements that make the design of moving parts capable of operating with different types of fuel complicated.

Fuel cells are electrochemical power generators that, similar to batteries, directly convert chemical energy to electricity. This direct conversion can lead to very high efficiency operation. State of the art cost effective fuel cells use hydrogen as their fuel. Therefore, to use fuel cells to extend the driving range of battery electric vehicles, hydrogen must be used as fuel or an onboard reformer must be employed.

Hydrogen is an attractive vehicle fuel because it can be generated from a large number of sources. The emissions of the vehicle would be only water vapor. Nonetheless, hydrogen is a fuel with low volumetric energy density. That is, the energy content of hydrogen contained in a certain volume is relatively small. As an example, FIG. 1 is a chart showing the gallons of fuel required to charge a 20 kWh battery pack. To provide 20 kWh of electrical energy using a fuel cell system to a vehicle's batteries, 14.2 gallons of hydrogen compressed to 5,000 psi would be needed as opposed to 2 gallons of diesel or gasoline. Liquid fuels have much higher energy content than hydrogen fuels, so even with the greater efficiency penalty associated with reformation, the quantity of fuel required is much lower.

If a fuel other than hydrogen is used with conventional fuel cells, then a reformer is needed. The reformer converts the fuel to a hydrogen-rich gas in a process that is typically catalytic. However, state of the art reformer catalysts are susceptible to sulfur content in the fuel. For this reason, gasoline and diesel reforming is a highly specialized task. Most gasoline or diesel reformers employ liquid sulfur traps, hydrodesulfurization reactors, or fractionation to reduce sulfur levels entering the reformer. These systems add complexity, cost, size and weight to the overall system.

Another barrier to the use of a varied range of fuels in a fuel cell system is that the fuel processor must be capable of reforming varying fuel blends. For example, commonly used gasoline is composed of a blend of heptane, isooctane, cyclopentane, ethylbenzene, and ethanol. A gasoline fuel processor must therefore be able to reform the complete fuel mixture effectively. Such a task is complicated because the reforming process is a balance between the endothermic hydrogen generating reactions and the oxidation energy producing reactions. A well-balanced reformer should have a net energy production of zero. However, each of the fuels in a fuel blend such as gasoline requires different amounts of energy for reformation and produce different amounts of energy when oxidized. Variations in fuel flow rate and fuel composition can destabilize the reforming reaction, thereby reducing efficiency, compromising hardware reliability, and potentially shutting down the reforming process.

The composition of the reformate influences fuel cell performance. In particular carbon monoxide (CO) and hydrogen sulfides are well known fuel cell poisons that can form as part of the reforming reaction. CO is problematic because its occurrence cannot be prevented. Hydrogen sulfides, on the other hand, can be eliminated through sulfur removal from the fuel.

CO degrades the anode of fuel cells by binding to active sites in the electrodes. In essence, the CO molecules compete for electrode sites with the hydrogen molecules. The level of CO activity in the anode electrode is highly dependent on temperature. As fuel cell temperature rises, CO activity is reduced and hydrogen activity is increased. State-of-the-art low temperature PEM fuel cells cannot withstand CO concentrations greater than 30 ppm in the reformate stream without major deterioration in performance. Low temperature PEM fuel cells operate from 60° C. to 80° C. High temperature PEM fuel cells, which operate from 120° C. to 200° C., have shown acceptable performance with reformate CO concentrations as high as 3%.

To control CO, fuel processors are outfitted with water gas shift reactors, palladium membrane separators, and/or pressure swing absorbers. These reactors add weight, size, cost, and complexity to the fuel cell system.

Thus, there is a need for a system that can minimize such concerns.

### SUMMARY

Embodiments are directed to a fuel flexible fuel cell system. The system can provide for a vehicle with a much higher driving range at a potentially lower cost than an equivalent range battery-only electric vehicle. The integration of these components into a single system also allows the vehicle to be fuel flexible; that is, capable of being fueled with a wide range of fuels without hardware changes in the system. The system can include a fuel source that includes one or more hydrogen-containing fuels. In one embodiment, the fuel source can contain a plurality of hydrogen-containing fuels.

The system also includes a fuel processor. The fuel processor is in fluid communication with the fuel source. The fuel processor produces hydrogen from the one or more hydrogen-containing fuels received from the fuel source. The fuel processor does not use a selective oxidizer for carbon monoxide (CO) removal. The system can include a heater for the fuel processor. The fuel processor can be operated at temperatures of at least about 600 degrees Celsius. The fuel processor can be an autothermal reformer, a microlith autothermal reformer, a monolith autothermal reformer or a steam reformer.

The system can include one or more high temperature PEM fuel cells. The fuel cell is capable of being operated at temperatures of at least 100 degrees Celsius. The fuel cell operates under transient conditions and steady state conditions. The fuel processor is in fluid communication with the fuel cell such that hydrogen produced by the fuel processor is supplied to the fuel cell. Hydrogen can be supplied from the fuel processor to the fuel cell during both transient conditions and steady state conditions of the fuel cell. Under steady state conditions, the fuel cell can operate in a range from about 120 degrees Celsius to about 200 degrees Celsius. When the fuel processor is an autothermal reformer, a cathode exhaust gas from the fuel cell can be directly introduced into the autothermal reformer so as to recover the water generated in the fuel cell.

The system can further include a data acquisition system. In one embodiment, the data acquisition system can be operatively connected to receive temperature data of the fuel processor. A controller can be operatively connected to the data acquisition system. Based on the temperature data of the fuel processor, the controller can adjust the rate of a fuel flow, an air flow and/or a water flow into the fuel processor. As a result, system efficiency can be optimized. The controller can adjust the rate of a fuel flow, an air flow and/or a water flow into the fuel processor without disconnecting the fluid communication between the fuel processor and the fuel cell. In another embodiment, based on the temperature data of the fuel processor, the controller can adjust the rate at which current is drawn from the fuel cell.

In another embodiment, a data acquisition system can be operatively connected to receive voltage data of the high temperature PEM fuel cell. A controller can be operatively connected to the data acquisition system. Based on the voltage of the high temperature PEM fuel cell, the controller can adjust the rate of a fuel flow, an air flow and/or a water flow into the fuel processor. As a result, system efficiency can be optimized. The controller can adjust the rate of a fuel flow, an air flow and/or a water flow into the fuel processor without disconnecting the fluid communication between the fuel processor and the fuel cell. The controller and/or the data acquisition system can be operatively connected to a look-up table database to determine a fuel flow, an air flow and/or a water flow into the fuel processor. In one embodiment, based on the voltage of the high temperature PEM fuel cell, the controller can adjust the rate at which current is drawn from the fuel cell.

### BRIEF DESCRIPTION OF THE DRAWINGS

FIG. 1 is a graph showing the gallons of fuel required to recharge a 20 kWh battery pack.

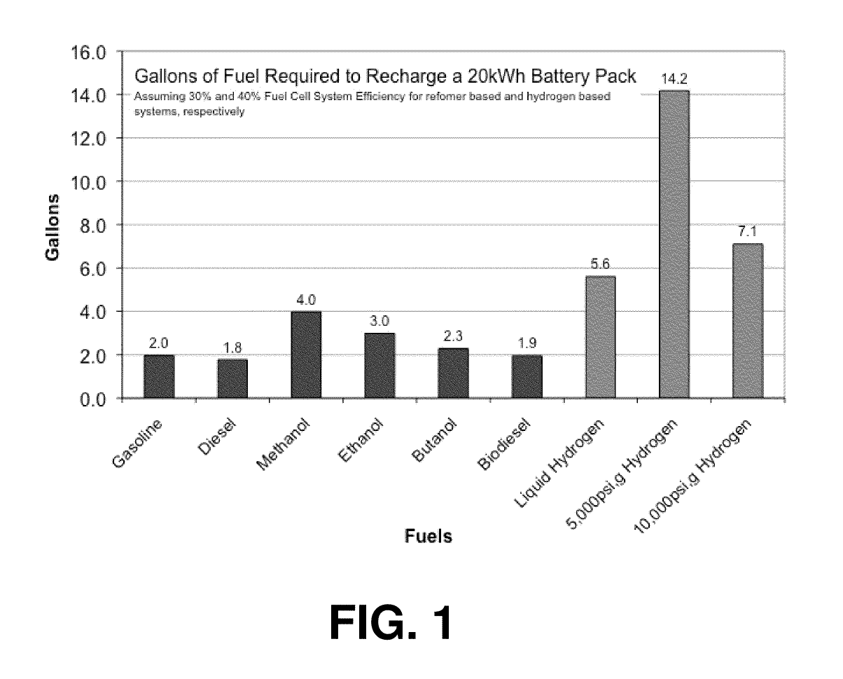

FIG. 2 is a diagrammatic view of energy flow in an electric vehicle having a power plant system.

FIG. 3 is a diagrammatic view of the electrical flow of an embodiment of an electric vehicle having a power plant system.

FIG. 4 is a diagrammatic view of an embodiment of a power plant system including an autothermal reformer.

FIG. 5 is a diagrammatic view of an embodiment of a power plant system including a steam reformer.

FIG. 6 is a diagrammatic view of a system for optimizing the flow rates of fuel, air and water into a fuel processor by using a feedback control loop based on look-up tables.

### DETAILED DESCRIPTION OF EMBODIMENTS

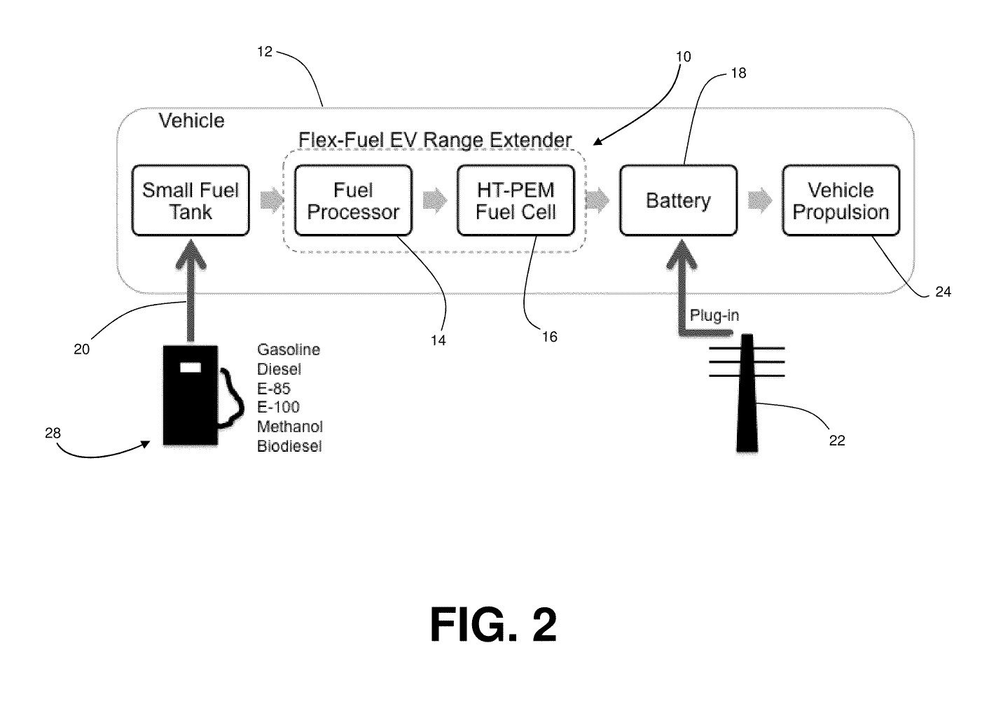

Embodiments are directed to a system for the propulsion of a vehicle, which can be any at least partly mechanical means of conveyance, including, for example, cars, motorcycles, trains, ships, boats, and aircraft, just to name a few possibilities. Various possible aspects will be explained herein, but the detailed description is intended only as exemplary. Embodiments are shown in FIGS. 2-6, but embodiments are limited to the illustrated structure or application. It will be appreciated that for simplicity and clarity of illustration, where appropriate, reference numerals have been repeated among the different figures to indicate like elements.

Referring to FIG. 2, a power plant system 10 can be integrated into a vehicle 12 in any suitable manner. The system 10 includes a fuel processor 14, a high temperature proton exchange membrane (PEM) fuel cell 16, and a battery pack 18 that can include one or more batteries. The battery pack 18 can include any suitable type of batteries. In one embodiment, the one or more batteries can be lithium ion batteries.

Energy can be introduced into the vehicle 12 via a fuel 20 and/or through coupling with an electric grid 22, as shown in FIG. 2. The energy in the vehicle 12 can be carried by the battery pack 18 and the fuel 20. In this system, the fuel cell 16 can be designed to provide sufficient power to support at least a portion of the vehicle's average power consumption during typical driving cycles. The fuel cell 16 can be primarily designed to recharge the vehicle batteries 18 and/or reduce the power draw from the batteries 18 to the vehicle propulsion system 24.

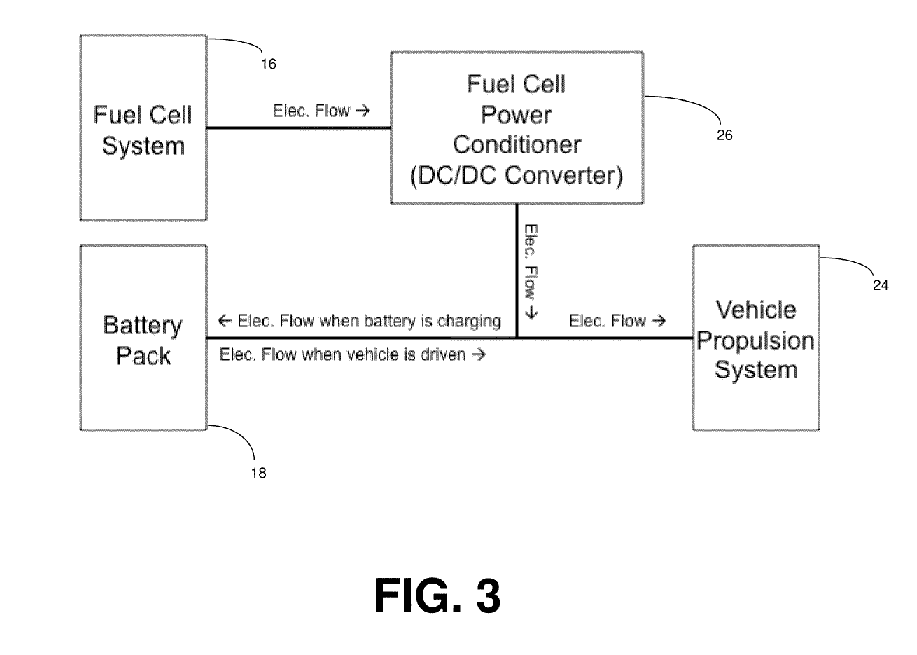

The battery 18 can be operatively connected to the fuel cell 16. The battery 18 can also be operatively connected to the vehicle electronic propulsion system 24. The term “operatively connected,” as used herein, can include direct or indirect connections, including connections without direct physical contact. In one embodiment, “operatively connected” can include power electronics and control electronics (not shown) that allow for the passage of electric power between the battery 18 and the fuel cell 16 and from the battery 18 to the vehicle electric propulsion system 24. The fuel cell 16 can be connected in parallel with the battery pack 18 and the vehicle propulsion system 24, as is shown in FIG. 3. A fuel cell power conditioner, such as a controlled power conditioner or DC/DC converter 26, can be operatively positioned between the fuel cell 16 and the battery pack 18 to control the flow of current from the fuel cell 16 to the battery 18 by voltage regulation.

In one embodiment, the fuel cell 16 and the fuel processor 14 may operate only at discrete conditions such that specific power outputs are generated by the fuel cell system 16. The discrete conditions may be, for example, trickle charge and temperature maintenance at 500 W and battery charging at 5 kW.

In one embodiment, the fuel cell 16 can be a high temperature PEM fuel cell. The high temperature PEM fuel cell 16 can include a solid or semi-solid electrolyte that is capable of proton conduction at temperatures in excess of 100° C. The high temperature PEM fuel cell 16 can operate within a temperature band between 120° C. to 200° C. during steady state operation. Within this range, the fuel cell can operate with CO concentrations as high as 3% and hydrogen sulfide concentrations as high as 10 ppm. The operating temperature can also reduce the susceptibility of the fuel cell 16 to low hydrogen concentration in the reformate.

A low temperature fuel cell, that is, a fuel cell with an operating temperature below 120° C. during steady state operation, would not be well suited for the present application. For instance, a low temperature fuel cell is susceptible to carbon monoxide poisoning, as it cannot handle high CO concentrations including concentrations at 3%. Further, a low temperature fuel cell cannot handle different hydrocarbon-based fuels. In addition, a low temperature fuel cell is highly susceptible to humidity, whereas a high temperature fuel cell is not. As a result, low temperature fuel cell systems include various extra features to avoid many of the problems that can occur due to humidity, making them overly complicated.

The high temperature PEM fuel cell system 16 can be air-cooled using fans that propel air through external fins that are part of the fuel cell system 16 or via cooling plates that form part of the fuel cell system 16. The use of air cooling can eliminate the need for liquid coolant, radiator, and pumps in the system, which, in turn, can reduce the overall cost, weight and size of the fuel cell system 16. The fuel cell 16 can be air-cooled using cathode air.

The system 10 can include any suitable type of fuel processor 14. For instance, the fuel processor 14 can be a reformer system, which can process one or more hydrocarbon-based fuels to produce hydrogen. Examples of a reformer system include a steam reformer and an autothermal reformer. The autothermal reformer has been demonstrated to have fast start-up and good resistance to sulfur contained in various fuels. The reformer can be designed such that it can reform a wide-ranging fuel blends. Thus, the fuel source 28 can include a plurality of hydrogen containing fuels. Each of these fuels can be hydrocarbon-based. The plurality of fuels can be different from each other. The plurality of fuels can be mixed together in the fuel source 28 or the plurality of fuels can be kept separate. The plurality of fuels can be introduced to the fuel processor 14 either together or at different times. The fuel processor 14 conversion efficiency and thermodynamic efficiency may vary with fuel blend. The fuel processor 14 may be capable of operating at temperatures of at least about 600° C.

The system 10 can include an analyzer (not shown) to determine the composition of the fuel blend being supplied into the fuel processor 14. However, it may be complicated or prohibitive to install an analyzer in the system 10. Thus, optimization of reformate quality by varying air to fuel ratio and water to fuel ratio can be done as the fuel processor 14 operates. For example, reformate quality can be estimated through real-time analysis of hydrogen and CO composition in the reformate gas, and/or by the temperature distribution inside the reformer and anode flue gas burner of the fuel cell system.

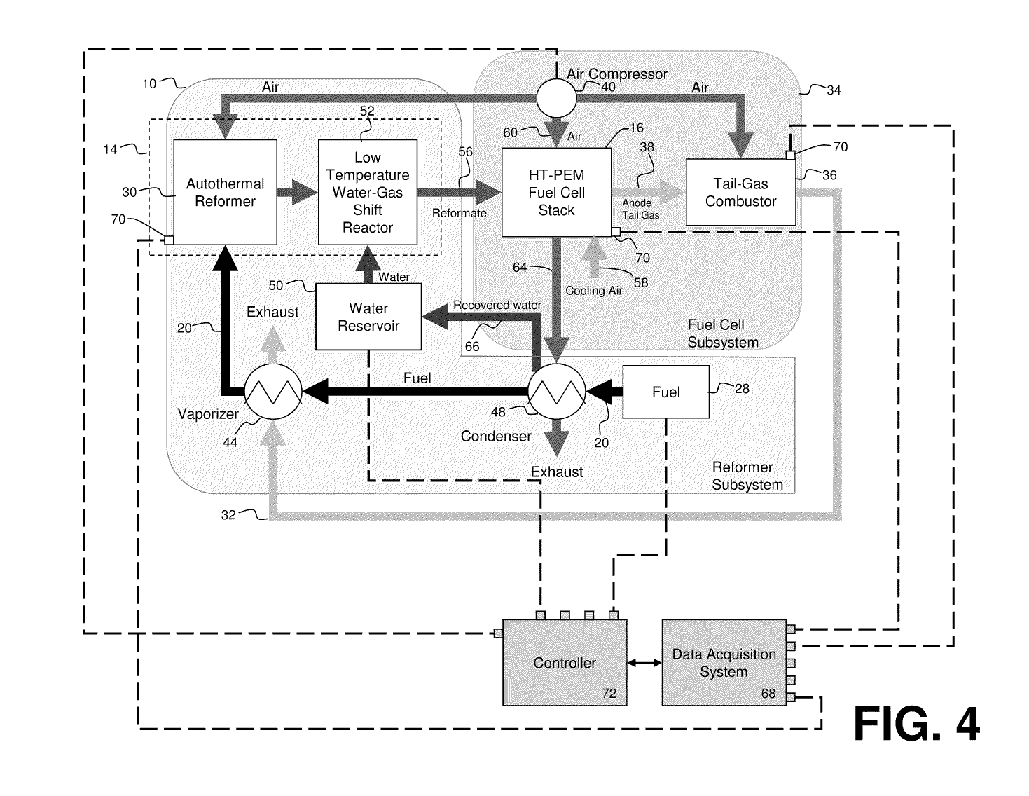

An example of a system 10 that has a fuel processor 14 that includes an autothermal reformer 30 is shown in FIG. 4. The system 10 can include various components. Generally, the system 10 can include a reformer subsystem 32 and a fuel cell subsystem 34. The fuel cell subsystem 34 can include a high temperature PEM fuel cell 16 and a tail-gas combustor 36 that primarily oxidizes hydrogen and other gases that did not participate in the fuel cell electrochemical oxidation reaction. The fuel cell 16 can be in fluid communication with the combustor 36. Thus, anode tail gas 38 from the fuel cell 16 can be supplied to the combustor 36. Anode tail gas 38 is a gas stream emanating from the fuel cell anode. The anode tail gas 38 can comprise the gases that did not participate in the fuel cell reaction and the portion of the hydrogen that was not reacted in the fuel cell 16. An air compressor 40 can induct and compress air from any suitable source, such as ambient air. The air compressor 40 can be in fluid communication to supply air to the fuel cell 16 as well as the combustor 36. The combustion products 42 generated by the combustor 36 can be exhausted to the atmosphere. Alternatively, the combustion products 42 from the combustor 36 can be supplied in heat exchanging relation to a vaporizer 44 before being exhausted to the atmosphere, as is shown in FIG. 4.

The reformer subsystem 32 can include a fuel source 46, a condenser 48, a water reservoir 50, a vaporizer 44, and a fuel processor 14. The fuel processor 14 can include a water-gas shift reactor 52 and an authothermal reformer 30. The autothermal reformer 30 can be a microlith autothermal reformer or a monolith autothermal reformer. The air compressor 40 can be in fluid communication with the autothermal reformer 30. Air from the compressor 40 can be supplied to the autothermal reformer 30 along with one or more fuels 20 from the fuel source 28.

The fuel source 28 can be in fluid communication with the autothermal reformer 30. Thus, one or more fuels 20 can be supplied to the autothermal reformer 30. Along the way, the one or more fuels 20 can be passed in heat exchanging relation through the condenser 48 to preheat or vaporize the fuel and to condense water from the fuel cell cathode exhaust 64. Alternatively or in addition, the one or more fuels 20 can pass in heat exchanging relation through the vaporizer 44 to further heat the fuel prior to entering the reformer 30. The combustion products 42 from the combustor 36 can be supplied in heat exchanging relation to a vaporizer 44.

After being processed by the autothermal reformer 30, the air-fuel mixture can be supplied to the water-gas shift reactor 52. In addition, water 54 from the water reservoir 50 can be supplied to the shift rector 52 and/or the autothermal reformer 30. The reformate 56 produced by the fuel processor 14 can be supplied to the fuel cell 16. Cooling air 60 and compressed air 62 can be supplied to the fuel cell 16. As noted above, anode tail gas 38 from the fuel cell 16 can be supplied to the tail-gas combustor 36.

Water recovery for introduction into the fuel processor 14 can be achieved in various ways. In the system shown in FIG. 4, water recovery for introduction into the fuel processor 14 can be achieved by condensation of the water contained in a cathode flue gas 64, which can be depleted air and water exiting the cathode of the fuel cell 16. The cathode flue gas 64 can pass in heat exchanging relation with a condenser 48. The recovered water 66 can be stored in the water reservoir 50. Such recovered water 50 can later be supplied to the fuel processor 14, such as to the low temperature water-gas shift reactor 52. The rest of the cathode flue gas 64 can be exhausted to the atmosphere.

Water recovery can be achieved in other suitable manners. For example, water recovery can be achieved by directing the unprocessed cathode flue gas 64 into the fuel processor 14. The cathode flue gas 64 may contain a sufficient amount of water and oxygen to promote the reforming reaction of most hydrocarbon blends. Such a method can reduce the size of the condenser 48 and can beneficially use the heat generated by the fuel cell 16 to increase the efficiency of the system 10.

The system 10 can include a data acquisition system 68. The data acquisition system 68 can be operatively connected to receive temperature data from the fuel processor 14 and/or voltage data from the fuel cell 16. One or more sensors 70 can be operatively associated with the fuel processor 14 and/or the fuel cell 16 to provide the desired data. The temperature data from the fuel processor 14 can be a temperature distribution along the fuel processor 14. The data acquisition system 68 can be operatively connected to a controller 72. The controller 72 can be comprised of hardware, software or any combination thereof. In one embodiment, the controller 72 can be part of the data acquisition system 68. For example, the controller 72 can be software installed on the data acquisition system 68. In another embodiment, the controller 72 can be separate from the data acquisition system 68 but operatively connected thereto.

The controller 72 can be operatively connected to various subcomponents of the system. For instance, the controller 72 can be operatively connected with the fuel source, the air compressor, and/or the water reservoir to control the flow of fluid from each source. In one embodiment, the fuel cell voltages and/or the reformer temperatures received by the data acquisition system can be used to optimize hydrogen conversion efficiency by varying the fuel flow rate, air flow rate and/or water flow rate into the reformer. That is, one or more of these flow rates can be increased or decreased. Changes in fuel flow rate, air flow rate and/or water flow rate into the hydrogen reformer can be made without disconnecting, bypassing and/or interrupting the fluid communication between the reformer and the fuel cell. Alternatively or in addition, the controller can be operatively connected to a power manager of fuel cell. By way of the power manager, the controller can regulate the amount of current that is drawn out of the fuel cell.

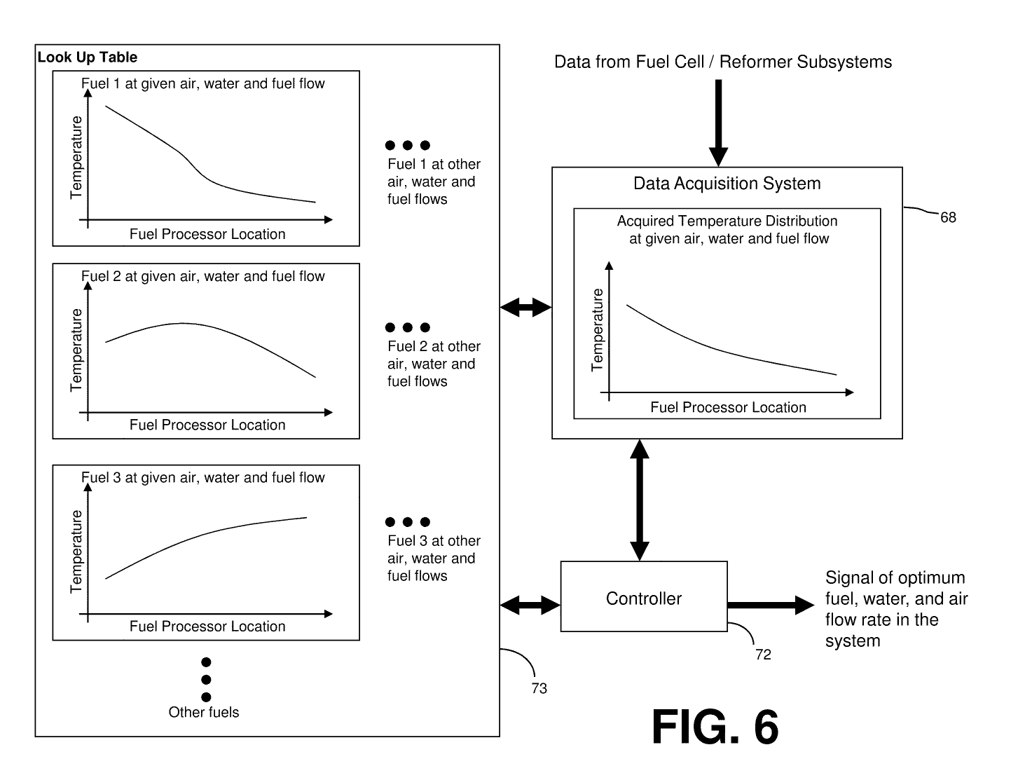

The control of the fuel flow rate, air flow rate and/or water flow rate into the hydrogen reformer can be achieved by a feedback control loop. The feedback control loop can be based on a look-up table of optimum temperatures for various potential hydrogen containing fuels or fuel blends. FIG. 6 shows an example of such a feedback control loop. Data from the fuel cell subsystem and/or the reformer subsystem can be received by the data acquisition system. Such data can include the current air, water, and/or fuel flow rates. A temperature distribution along the fuel processor can be acquired. Based on this data, the data acquisition system 68 and/or the controller 72 can operatively connect to a look-up table 73. The look-up table 73 can include a database of temperature distributions for various fuels at various given air, water, and/or fuel flow rates into the fuel processor. The closest temperature distribution in the look-up table to the acquired temperature distribution. Based on this, the water, air and/or fuel flow rates can be adjusted to optimize operation at the given fuel cell power level. The controller 72 and/or the data acquisition system 68 can send a signal to the fuel source, the air compressor, and/or the water reservoir to adjust the flow rate from each source into the fuel processor accordingly.

Alternatively or in addition to look-up tables, the feedback control loop can be based on a trained neural network or neurofuzzy controller. It should be noted that the controller can selectively vary one of the fuel flow rate, air flow rate and/or water flow rate into the hydrogen reformer to find the optimum flow rate.

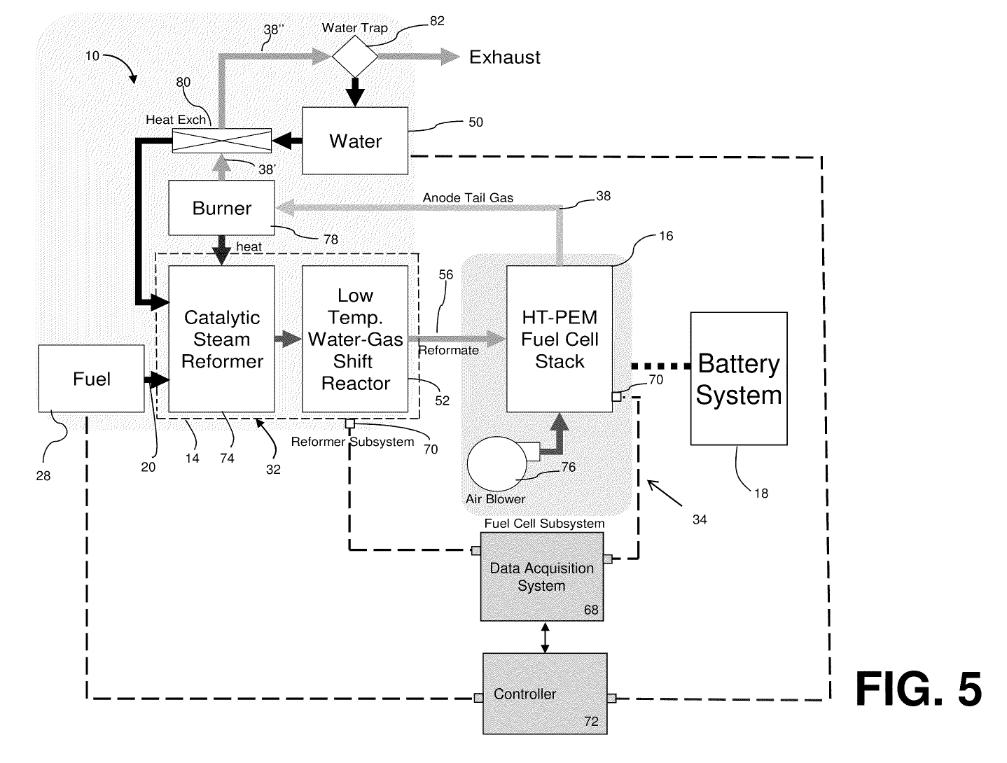

A system using a higher hydrocarbon steam reformer 74 could also be employed. One example of such a system is shown in FIG. 5. The system 10 can include a reformer subsystem 32 and a fuel cell subsystem 34. The fuel cell subsystem 34 can include a high temperature PEM fuel cell 16. An air blower 76 can be in fluid communication with the fuel cell 16. In such case, water recovery can be achieved by using the flue gas from the reformer (not shown) and/or a burner 78. Anode flue gas 38 from the fuel cell 16 can be supplied to the burner 78. The heat from the burner 78 can be supplied to the steam reformer 74. The heated flue gas 38 can be passed in heat exchanging relation with a heat exchanger 80. The flue gas 38 can then be passed through a water trap 82, which can collect water from the flue gas 38. The water from the water trap 82 can be stored in the water reservoir 50. After the water is extracted, the flue gas 38 can be exhausted to the atmosphere.

The water reservoir 50 can be in fluid communication with the fuel processor 14, such as the steam reformer 74. In one embodiment, the water from the reservoir 50 can be passed in heat exchanging relation with the heat exchanger 80 to form steam. The steam can be supplied to the steam reformer 74.

The system can include a data acquisition system 68, sensors 70 and a controller 72. The above description of the data acquisition system 68, sensors 70 and the controller 72 made in connection with the embodiment shown in FIG. 4 is equally applicable to the embodiment of FIG. 5. However, it is noted that, in this embodiment, there is no air supply to the fuel processor 14. Thus, the controller 72 can adjust the rate of fuel flow and/or water flow into the fuel processor 14.

Systems described herein can provide significant benefits. For instance, the system can allow a vehicle to have a much higher driving range at a potentially lower cost than an equivalent range battery-only electric vehicle. Further, the integration of a battery pack, a high temperature PEM fuel cell and a fuel processor into a single system can allow a vehicle to be fuel flexible; that is, the vehicle can be fueled with a wide range of fuels without hardware changes in the system. Examples of suitable fuel used for the fuel cell system include gasoline, diesel, bio-derived fuels, methanol, ethanol propane, butane and natural gas and/or alcohols, just to name a few possibilities. The fuel can be any hydrogen bearing fuel, hydrocarbon fuel or other hydrogen fuel source such as ammonia. Examples of possible fuels include gasoline, diesel, E-85, E-100, Methanol and Biodiesel. The fuel can be combinations of different fuels. These fuels can be added together or at different times. These improvements over existing systems are possible because the system can augment synergic processes among components and reduce technical limitations.

The system can for an expansion of operability and performance among all other systems. For instance, the system can ensure sufficient energy storage in batteries to complete (or near complete) average driving ranges reduces the amount of fuel the vehicle must carry to achieve a certain driving range. The battery pack can supply most of the vehicle electric power demands, while the fuel cell can supports either the average drive cycle power requirement or the average daily vehicle power requirements. As a result, the required power output of the fuel cell is reduced in comparison to a pure fuel cell vehicle. A reduction in fuel cell power requirements results in lower fuel cell generator costs. Additionally, this reduces the size and cost of the reformer.

Further, the batteries can minimize or eliminate the need for variable power output from the fuel cell and variable hydrogen output from the reformer. The primary barrier to fuel flexibility in a reformer is due to the complexity in catalytic reactor and fluid flow design capable of reforming a variable blend of fuels. However, establishing a single or series of discrete hydrogen output flow rates for the reformer can drastically simplify the reactor design for fuel blends. This can also eliminate the problem of turndown ratio in the reformer. As a result, the reformer catalyst bed can be designed to meet the variations in fuel blend to achieve a certain hydrogen flow rate without accounting for transient thermal behavior in the reformer. As part of the reformer startup process a PID (proportional, integral, derivative) controller can identify the correct reactant flow rates to achieve the single desired hydrogen flow rate and the process can be maintained throughout the complete operating cycle. In addition, the elimination of variable power outputs can also reduces complexity in fuel cell stack and associated systems design. In particular, cooling, reactant flow design, tail gas combustor design, and water recovery subsystems can be optimized for the discrete operating conditions.

The inclusion of a fuel cell system reduces the number of batteries required to achieve a certain driving range in comparison with a battery only electric vehicle. The energy content of the fuel cell system is that of the fuel stored in the vehicle. The reformer and fuel cell system using a liquid fuel can have much higher gravimetric energy density than the most advanced batteries. Therefore, the desired driving range can be achieved with lower vehicle weight than if a battery-only vehicle were to be designed.

The use of a high temperature PEM fuel cell system allows for fuel flexibility in the system by expanding the range of acceptable hydrogen, carbon monoxide, and hydrogen sulfide concentrations in the reformate gas stream. High temperature PEM fuel cells can operate at a temperature between 120° C. to 200° C.; therefore, the level of fuel cell susceptibility to reformate quality variations is reduced and variations in fuels, which cause variations in reformate quality, do not damage or drastically hinder the performance of the fuel cell. Additionally, the use of a high temperature PEM fuel cell system can eliminate the need for expensive hydrogen cleanup schemes such as palladium membranes, pressure swing absorbers and preferential oxidizers.

The presence of the fuel cell system can reduce complexity in fast charging battery packs. The trickle charge in battery charging is the portion that takes the longest amount of time. This portion can be done with the fuel cell system, thus reducing the time that a vehicle needs to be tied to the electric grid.

The penalty for climate control for electric vehicles can be eliminated or reduced. Climate control (AC and cabin heating) consumes a substantial portion of the vehicle's energy. Therefore, use of climate control reduces the driving range of the vehicle. The high temperature PEM fuel cell system and the reformer can provide heat to the cabin while recharging batteries in winter months. If recharging is done while the vehicle is parked, the user can return to a vehicle already warmed and acclimated. During summer, the fuel cell system can defray the energy required to operate the vehicle air conditioning unit. Since electric vehicles may first be deployed in fleet to service personnel, post offices, and police officers, these vehicles may require the capacity to idle while acclimating the vehicle cabin for long periods of time. The presence of the fuel cell can allow for this.

While the embodiments have been described with reference to an exemplary embodiment, it will be understood by those skilled in the art that various changes may be made and equivalents may be substituted for elements thereof without departing from the scope of the embodiments herein. In addition, many modifications may be made to adapt a particular situation or material to the teachings of the embodiments herein without departing from the essential scope thereof. Thus, it will be understood that the embodiments herein are not limited to the specific details described herein, which are given by way of example only, and that various modifications and alterations are possible within the scope of the following claims.

What is claimed is:

1. A fuel flexible fuel cell system comprising:
a fuel source including at least one hydrogen-containing fuel therein;
a fuel processor in fluid communication with the fuel source, the fuel processor producing hydrogen from the at least one hydrogen-containing fuel received from the fuel source, wherein the fuel processor does not use a selective oxidizer for CO removal;
a heater for the fuel processor; and
at least one high temperature PEM fuel cell, the fuel cell capable of being operated at temperatures of at least 100 degrees Celsius, the fuel cell operating under transient conditions and steady state conditions, the fuel processor being in fluid communication with the fuel cell such that hydrogen produced by the fuel processor is supplied to the fuel cell,
wherein hydrogen is supplied from the fuel processor to the fuel cell during both transient conditions and steady state conditions of the fuel cell.

2. The system of claim 1 wherein the fuel processor is an autothermal reformer.

3. The system of claim 2 wherein the fuel processor is a microlith autothermal reformer.

4. The system of claim 2 wherein the fuel processor is a monolith autothermal reformer.

5. The system of claim 1 wherein the fuel processor is a steam reformer.

6. The system of claim 1 wherein the fuel processor is capable of being operated at temperatures of at least about 600 degrees Celsius.

7. The system of claim 1 wherein, under steady state conditions, the fuel cell operates in a range from about 120 degrees Celsius to about 200 degrees Celsius.

8. The system of claim 1 wherein the fuel source contains a plurality of hydrogen-containing fuels.

9. The system of claim 1 further including a data acquisition system operatively connected to receive temperature data of the fuel processor.

10. The system of claim 9 further including a controller operatively connected to the data acquisition system, wherein, based on the temperature data of the fuel processor, the controller adjusts the rate of at least one of a fuel flow, an air flow and a water flow into the fuel processor, whereby system efficiency is optimized.

11. The system in claim 10 wherein the controller adjusts the rate of at least one of a fuel flow, an air flow and a water flow into the fuel processor without disconnecting the fluid communication between the fuel processor and the fuel cell.

12. The system of claim 9 further including a controller operatively connected to the data acquisition system, wherein, based on the temperature data of the fuel processor, the controller adjusts the rate at which current is drawn from the fuel cell.

13. The system of claim 1 further including a data acquisition system operatively connected to receive voltage data of the high temperature PEM fuel cell.

14. The system of claim 13 further including a controller operatively connected to the data acquisition system, wherein, based on the voltage of the high temperature PEM fuel cell, the controller adjusts the rate of at least one of a fuel flow, an air flow and a water flow into the fuel processor, whereby system efficiency is optimized.

15. The system of claim 14 wherein the controller adjusts the rate of at least one of a fuel flow, an air flow and a water flow into the fuel processor without disconnecting the fluid communication between the fuel processor and the fuel cell.

16. The system of claim 14 wherein one of the controller and the data acquisition system is operatively connected to a look-up table database to determine at least one of a fuel flow, an air flow and a water flow into the fuel processor.

17. The system of claim 13 further including a controller operatively connected to the data acquisition system, wherein, based on the voltage of the high temperature PEM fuel cell, the controller adjusts the rate at which current is drawn from the fuel cell.

18. The system of claim 2 wherein a cathode exhaust gas from the at least one high temperature PEM fuel cell is directly introduced into the autothermal reformer, whereby water generated in the at least one high temperature PEM fuel cell can be recovered.
